(19) United States
(12) Patent Application Publication
(10) Pub. No.: US 2013/0230694 A1
(43) Pub. Date: Sep. 5, 2013

(54) Far Infrared Ray Wooden Floor

(71) Applicant: Cheng-Yi SU, Douliu City (TW)

(72) Inventor: Cheng-Yi SU, Douliu City (TW)

(21) Appl. No.: 13/411,526

(22) Filed: Mar. 3, 2012

(51) Int. Cl. B32B 21/08; B32B 21/04; B32B 18/00

(52) U.S. Cl. 428/142; 428/448

(57) ABSTRACT

A far infrared ray wooden floor includes a wooden base layer, a first far infrared ray layer, a first undercoating layer, a resistant layer, a resistant finish layer and a finishing layer. The first far infrared ray layer is coated on the base layer. The first undercoating layer is disposed on the first far infrared ray layer. The resistant layer is disposed on the first undercoating layer. The second undercoating layer is disposed on the resistant layer. The resistant finish layer is disposed on the second undercoating layer. The finishing layer is disposed on the resistant finish layer. The first resistant layer is provided for emitting far infrared rays and medical care effects. The resistant layer and resistant finish layer can provide protective effects and strengthen the first far infrared ray layer.

### BACKGROUND OF THE INVENTION

1. Field of the Invention

The present invention relates to a floor structure, and more particularly to a far infrared ray wooden floor.

2. Description of Related Art

The far infrared ray (FIR) is a kind of light beam and electromagnetic wave for health purpose and has a penetrating and absorbing nature. Based on researches, the FIR can deeply penetrate and be in resonance with the human tissue, such that the cells in human body absorb the energy of FIR and are activated to increase the circulation among the cells and blood capillaries. The tissue might eliminate the unhealthy matters from the human body to provide a prophylactic effect. Therefore, FIR is broadly applied for daily use to provide medical care effects.

It is known that the FIR technology can be utilized on textiles for keeping warm and sterilization. However, there is no utilization which applies the FIR technology to the wooden articles, especially to the wooden floor.

To overcome the shortcomings, the present invention tends to provide a far infrared ray wooden floor to mitigate or obviate the aforementioned problems.

### SUMMARY OF THE INVENTION

The main objective of the invention is to provide a far infrared ray wooden floor that includes a wooden base layer having a usage surface; a first far infrared ray layer disposed on the usage surface, the first far infrared ray layer being formed by 10-40 wt % of far infrared ray emitting nano-particles and 60-90 wt % of solvent; a first undercoating layer disposed on the first far infrared ray layer; a resistant layer disposed on the first undercoating layer, the resistant layer being formed by 1-30 wt % of aluminium oxide and 99-70 wt % of solvent; a second undercoating layer disposed on the resistant layer; a resistant finish layer disposed on the second undercoating layer, the finishing layer being formed by 1-30 wt % of scratch resistant ceramic and 99-70 wt % of solvent and a finishing layer disposed on the resistant finish layer.

In accordance with another aspect of the present invention, the far infrared ray structure of a second embodiment further includes a third undercoating layer disposed on the usage surface of the wooden base layer and located between the wooden base layer and the first undercoating layer.

In accordance with another aspect of the present invention, the far infrared ray structure of a third embodiment further includes a surface layer disposed between the first far infrared ray layer and the first undercoating layer, the surface layer being a wood-like grain sheet and being adhered on the first far infrared ray layer; a second far infrared ray layer disposed on the first undercoating layer and located between the first undercoating layer and the resistant layer, the second far infrared ray layer being formed by 10-40 wt % of far infrared ray emitting nano-particles and 60-90 wt % of solvent; and a fourth undercoating layer disposed on the second far infrared ray layer and located between the second far infrared ray layer and the resistant layer.

In accordance with another aspect of the present invention, the far infrared ray structure of a fourth embodiment further includes a surface layer disposed between the first far infrared ray layer and the first undercoating layer, the surface layer being a wood-like grain sheet and being adhered on the first far infrared ray layer; and a third far infrared ray layer disposed on the surface layer and located between the surface layer and the first undercoating layer, the third far infrared ray layer being formed by 10-40 wt % of far infrared ray emitting nano-particles and 60-90 wt % of solvent.

Other objects, advantages and novel features of the invention will become more apparent from the following detailed description when taken in conjunction with the accompanying drawings.

### BRIEF DESCRIPTION OF THE DRAWINGS

FIG. 1 is a perspective view in partial section of a far infrared ray wooden floor in accordance with the present invention;

FIG. 2 is an enlarged cross-sectional side view of FIG. 1;

FIG. 3 is a cross-sectional side view of a second embodiment of a far infrared ray structure in accordance with the present invention;

FIG. 4 is a cross-sectional side view of a third embodiment of a far infrared ray structure in accordance with the present invention; and

FIG. 5 is a cross-sectional side view of a fourth embodiment of a far infrared ray structure in accordance with the present invention.

### DETAILED DESCRIPTION OF PREFERRED EMBODIMENT

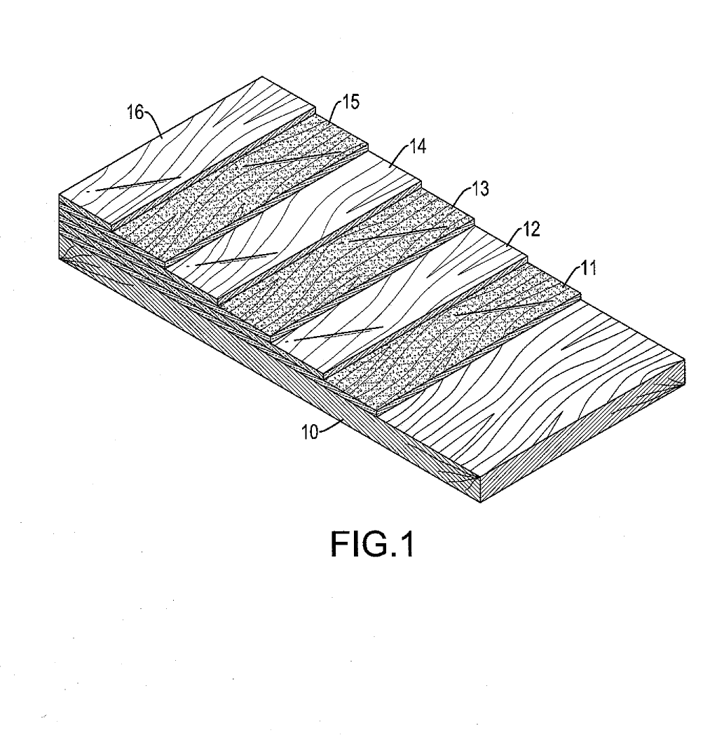

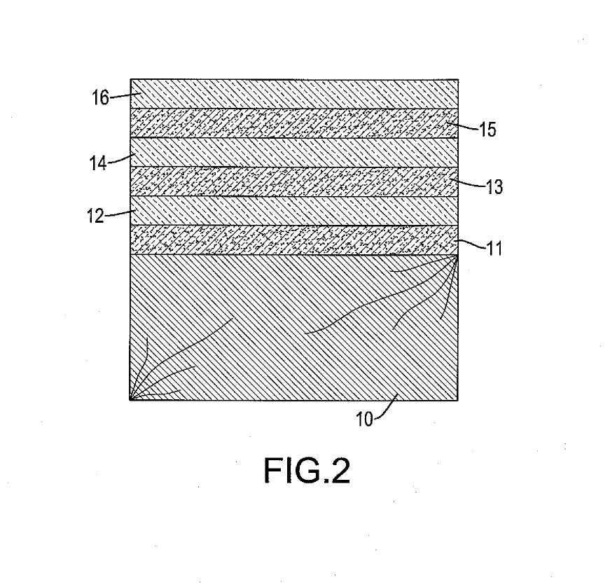

With reference to FIGS. 1 and 2, a far infrared ray wooden floor in accordance with the present invention comprises a wooden base layer 10, a first far infrared ray layer 11, a first undercoating layer 12, a resistant layer 13, a second undercoating layer 14, a resistant finish layer 15 and a finishing layer 16.

The wooden base layer 10 could be a timber sheet for being mounted on the ground surface as a floor. The wooden base layer 10 has a usage surface disposed on a top of the wooden base layer 10.

The first far infrared ray layer 11 is disposed on the usage surface of the wooden base layer 10. Preferably, the first far infrared ray layer 11 is coated on the usage surface of the wooden base layer 10. The first far infrared ray layer 11 is formed by 10-40 wt % of far infrared ray emitting nano-particles and 60-90 wt % of solvent. The far infrared ray emitting nano-particles are zinc oxide particles for emitting far infrared rays. The solvent could be chosen from the group consisting of organic solvent, olive oil, palm oil, flaxseed oil, water, glue, and acrylic resin. Preferably, the first far infrared ray layer 11 is formed by 87 wt % of acrylic resin and 13 wt % of zinc oxide particles. The zinc oxide can continuously emit far infrared rays for providing a medical care effect.

The first undercoating layer 12 is formed by acrylic resin and is disposed on the first far infrared ray layer 11. Preferably, the first undercoating layer 12 is coated on the first far infrared ray layer 11

The resistant layer 13 is disposed on the first undercoating layer 12. Preferably, the resistant layer 13 is coated on the first undercoating layer 12 and the resistant layer 13 is formed by 1-30 wt % of aluminium oxide and 99-70 wt % of solvent. The composition of the solvent is mentioned as above described. Preferably, the resistant layer 13 is formed by 95 wt % of acrylic resin and 5 wt % of aluminium oxide. The aluminium oxide can strengthen and protect the first undercoating layer 12 for increasing the wearing resistance.

The second undercoating layer 14 is formed by acrylic resin and is disposed on the resistant layer 13. Preferably, the second undercoating layer 14 is coated on the resistant layer 13

The resistant finish layer 15 is disposed on the second undercoating layer 14. Preferably, the resistant finish layer 15 is coated on the second undercoating layer 14. The finishing layer 16 is formed by 1-30 wt % of scratch resistant ceramic and 99-70 wt % of solvent. The composition of the solvent is mentioned as above described. Preferably, the resistant finish layer 15 is formed by 95 wt % of acrylic resin and 5 wt % of scratch resistant ceramic. The ceramic material can increase the rigidity for providing a further protective effect and preventing scuffing.

The finishing layer 16 is disposed on the resistant finish layer 15. Preferably, the finishing layer 16 is coated on the resistant finish layer 15. The finishing layer 16 is provided for increasing the colour and the polish.

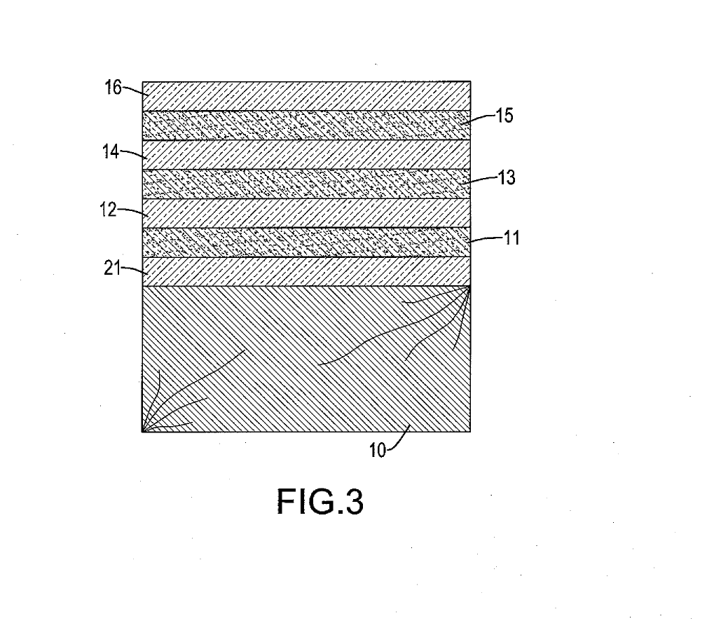

With reference to FIG. 3, in the second embodiment of the far infrared ray structure in accordance with the present invention, the elements and effects of the second embodiment are same with the first embodiment except that a third undercoating layer 21 is disposed on the usage surface of the wooden base layer 10 and located between the wooden base layer 10 and the first undercoating layer 12. Preferably, the third undercoating layer 21 is coated on the usage surface of the wooden base layer 10 and is formed of varnish.

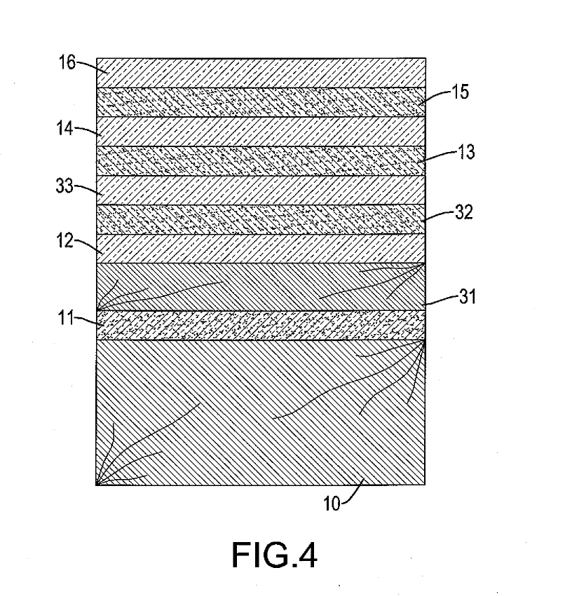

With reference to FIG. 4, in the third embodiment of the far infrared ray structure in accordance with the present invention, the elements and effects of the third embodiment are same with the first embodiment except for a surface layer 31, a second far infrared ray layer 32, a fourth undercoating layer 33, and the finishing layer 16 being a UV curable coating.

The surface layer 31 is disposed between the first far infrared ray layer 11 and the first undercoating layer 12. The surface layer 31 is formed by material of wooden strings and is adhered on the first far infrared ray layer 11. Preferably, the surface layer 31 is a wood-like grain sheet for providing beautification.

The second far infrared ray layer 32 is disposed on the first undercoating layer 12 and is located between the first undercoating layer 12 and the resistant layer 13. Preferably, the second far infrared ray layer 32 is coated on the first undercoating layer 12. The second far infrared ray layer 32 is formed by 10-40 wt % of far infrared ray emitting nano-particles and 60-90 wt % of solvent. The far infrared ray emitting nano-particles are zinc oxide particles. The composition of the solvent is mentioned as above described. Preferably, the second far infrared ray layer 32 is formed by 87 wt % of acrylic resin and 13 wt % of zinc oxide particles. The fourth undercoating layer 33 is disposed on the second far infrared ray layer 32 and located between the second far infrared ray layer 32 and the resistant layer 13. Preferably, the fourth undercoating layer 33 is coated on the second far infrared ray layer 32 and is formed by acrylic resin.

The UV curable coating of the finishing layer 16 is sprayed on the resistant finish layer 15 and is illuminated by ultraviolet to be hardened, such that both of the finishing layer 16 and the resistant finish layer 15 can provide a protective effect.

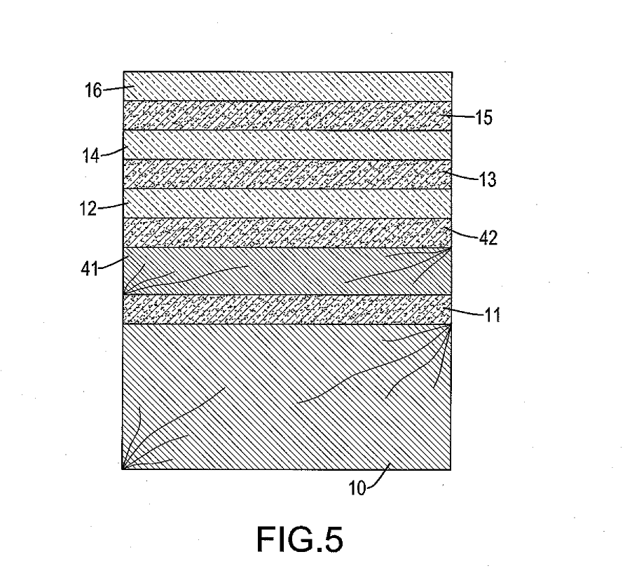

With reference to FIG. 5, in the fourth embodiment of the far infrared ray structure in accordance with the present invention, the elements and effects of the fourth embodiment are same with the first embodiment except for a surface layer 41, a third far infrared ray layer 42, and the finishing layer 16 being a UV curable coating.

The surface layer 41 is disposed between the first far infrared ray layer 11 and the first undercoating layer 12. The surface layer 41 is formed by material of wooden strings and is adhered on the first far infrared ray layer 11. Preferably, the surface layer 41 is a wood-like grain sheet for providing beautification.

The third far infrared ray layer 42 is disposed on the surface layer 41 and is located between the first undercoating layer 12 and the surface layer 41. Preferably, the third far infrared ray layer 42 is coated on the surface layer 41. The third far infrared ray layer 42 is formed by 10-40 wt % of far infrared rayemitting nano-particles and 60-90 wt % of solvent. The far infrared ray emitting nano-particles are zinc oxide particles. The composition of the solvent is mentioned as above described. Preferably, the third far infrared ray layer 42 is formed by 87 wt % of acrylic resin and 13 wt % of zinc oxide particles. The UV curable coating of the finishing layer 16 is sprayed on the resistant finish layer 15 and is illuminated by ultraviolet to be hardened, such that both of the finishing layer 16 and the resistant finish layer 15 can provide a protective effect.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A far infrared ray wooden floor comprising:
a wooden base layer having a usage surface;
a first far infrared ray layer disposed on the usage surface, the first far infrared ray layer being formed by 10-40 wt % of far infrared rayemitting nano-particles and 60-90 wt % of solvent;
a first undercoating layer disposed on the first far infrared ray layer;
a resistant layer disposed on the first undercoating layer, the resistant layer being formed by 1-30 wt % of aluminium oxide and 99-70 wt % of solvent;
a second undercoating layer disposed on the resistant layer;
a resistant finish layer disposed on the second undercoating layer, the finishing layer being formed by 1-30 wt % of scratch resistant ceramic and 99-70 wt % of solvent; and
a finishing layer disposed on the resistant finish layer.

2. The far infrared ray wooden floor as claimed in claim 1, wherein the far infrared ray emitting nano-particles are zinc oxide particles.

3. The far infrared ray wooden floor as claimed in claim 2, wherein the solvent is chosen from the group consisting of organic solvent, olive oil, palm oil, flaxseed oil, and acrylic resin.

4. The far infrared ray wooden floor as claimed in claim 3, wherein the first undercoating layer and the second undercoating layer are formed by acrylic resin.

5. The far infrared ray wooden floor as claimed in claim 1 further comprising:
a third undercoating layer disposed on the usage surface of the wooden base layer and located between the wooden base layer and the first undercoating layer.

6. The far infrared ray wooden floor as claimed in claim 5, wherein the far infrared ray emitting nano-particles are zinc oxide particles.

7. The far infrared ray wooden floor as claimed in claim 6, wherein the solvent is chosen from the group consisting of organic solvent, olive oil, palm oil, flaxseed oil, and acrylic resin.

8. The far infrared ray wooden floor as claimed in claim 7, wherein the first undercoating layer and the second undercoating layer are formed by acrylic resin, and the third undercoating layer is formed of varnish.

9. The far infrared ray wooden floor as claimed in claim 1 further comprising:
a surface layer disposed between the first far infrared ray layer and the first undercoating layer, the surface layer being a wood-like grain sheet and being adhered on the first far infrared ray layer;
a second far infrared ray layer disposed on the first undercoating layer and located between the first undercoating layer and the resistant layer, the second far infrared ray layer being formed by 10-40 wt % of far infrared ray emitting nano-particles and 60-90 wt % of solvent;
a fourth undercoating layer disposed on the second far infrared ray layer and located between the second far infrared ray layer and the resistant layer.

10. The far infrared ray wooden floor as claimed in claim 9, wherein the far infrared ray emitting nano-particles are zinc oxide particles.

11. The far infrared ray wooden floor as claimed in claim 10, wherein the solvent is chosen from the group consisting of organic solvent, olive oil, palm oil, flaxseed oil, and acrylic resin.

12. The far infrared ray wooden floor as claimed in claim 11, wherein the finishing layer is a UV curable coating.

13. The far infrared ray wooden floor as claimed in claim 12, wherein the first undercoating layer, the second undercoating layer, and the fourth undercoating layer are formed by acrylic resin.

14. The far infrared ray wooden floor as claimed in claim 1 further comprising:
a surface layer disposed between the first far infrared ray layer and the first undercoating layer, the surface layer being a wood-like grain sheet and being adhered on the first far infrared ray layer;
a third far infrared ray layer disposed on the surface layer and located between the surface layer and the first undercoating layer, the third far infrared ray layer being formed by 10-40 wt % of far infrared ray emitting nano-particles and 60-90 wt % of solvent.

15. The far infrared ray wooden floor as claimed in claim 14, wherein the far infrared ray emitting nano-particles are zinc oxide particles.

16. The far infrared ray wooden floor as claimed in claim 15, wherein the solvent is chosen from the group consisting of organic solvent, olive oil, palm oil, flaxseed oil, and acrylic resin.

17. The far infrared ray wooden floor as claimed in claim 16, wherein the finishing layer is a UV curable coating.

18. The far infrared ray wooden floor as claimed in claim 17, wherein the first undercoating layer and the second undercoating layer are formed by acrylic resin.

19. The far infrared ray wooden floor as claimed in claim 1, wherein the solvent is chosen from the group consisting of organic solvent, olive oil, palm oil, flaxseed oil, and acrylic resin.

20. The far infrared ray wooden floor as claimed in claim 1, wherein the finishing layer is a UV curable coating.
